(19) United States
(12) Patent Application Publication
(10) Pub. No.: US 2012/0091171 A1
(43) Pub. Date: Apr. 19, 2012

(54) DUST CAP FOR A BOTTLE POUR SPOUT

(76) Inventors: Clyde Bahnson Lovelace, III, Asheville, NC (US); Jason Larson, Asheville, NC (US)

(21) Appl. No.: 12/903,509

(22) Filed: Oct. 13, 2010

(51) Int. Cl. B65D 47/00; B67D 3/00

(52) U.S. Cl. 222/562; 222/481.5; 222/1

(57) ABSTRACT

A dust cover is provided for selectively blocking a pour spout nozzle to prevent the entry of insects, dust, or other substances into a container such as a bottle on which the pour spout is mounted. The dust cover can be molded as a single piece composed of any selected fibrous material or non-fibrous material, whether fully or partially biodegradable or not biodegradable.

### BACKGROUND OF THE INVENTION

The present invention relates to a dust cap for a pour spout for a bottle or other container.

In retail outlets such as restaurants that serve alcoholic beverages along with food, as well as in establishments such as bars, taverns, nightclubs and other entertainment venues in which alcoholic beverages are served, there is a well-known practice in the handling of bottles and other containers whose original bottle cap has been removed. Specifically, it is a customary practice to replace the original bottle cap of these opened liquor bottles or other beverage bottles with a pour spout that enables the bar attendant to pour an appropriate portion of liquor into a glass or into a measuring container such as a jigger (with the contents of the measuring container then being poured into a glass). The pour spout is inserted into the neck of the bottle and projects outwardly from the mouth of the bottle at the top of the neck of the bottle and the pour spout has a nozzle through which the liquid is dispensed into the glass or container. Although the pour spout nozzle is typically smaller than the mouth of the bottle on which the pour spout is mounted, this nozzle is nonetheless an enticing entry point for fruit flies or other nuisance insects that are attracted to the liquor retained in the bottle. The small size of fruit flies, and certain other insects, permits these insects to pass through the pour spout and into the bottle. In such a situation, the entire bottle must be considered to be contaminated and prudent beverage serving protocol requires that the remaining liquor inside the bottle must be discarded. Over time, the contamination of liquor bottles by fruit flies, or other insects, can result in significant monetary losses. Furthermore, other contaminants may also be able to undesirably enter the bottle through the pour spout.

Several existing methods are used in those establishments serving alcoholic beverages to deal with this problem. For example, pour spouts are commercially available that have a flip cover that opens when being poured. However, these covers are prone to breaking off, sticking closed when the bottle is being poured, and can be left in an open position such that the pour spout is not sealed, which still allows some fruit flies, or other insects, to enter the bottle.

Another method of expediency is to stretch plastic wrap or place a small disposable paper cup over each top opening of a pour spout or, if the liquor bottles have not been capped with pour spouts, to stretch the plastic wrap or place small disposable paper cups over the liquor bottles themselves. These approaches detrimentally open the door for unhygienic handling practices and it cannot be counted on that the plastic wrap or cups will remain in place—i.e., these temporary covers may be inadvertently dislodged from their capping positions.

### SUMMARY OF THE INVENTION

It is therefore an object of the present invention to provide for selectively blocking a pour spout nozzle to prevent the entry of insects, dust, or other substances into a container such as a bottle on which the pour spout is mounted that is convenient in use yet is suitable for sound environmental practices in an establishment.

One embodiment of the invention employs a dust cover, the dust cover being disposable on a nozzle of a pour spout of the type that is positionable relative to the mouth of a neck of a bottle or other container to guide the dispensing of a substance from the bottle or other container, and the dust cover comprising a skirt portion, the skirt portion delimiting a receipt opening and a base portion, the skirt portion and the base portion together delimiting an interior space having a cover axis, the receipt opening delimited by the skirt portion forming one axial end of the interior space and the base portion forming an opposite axial end of the interior space, the receipt opening being compatibly configured with respect to a nozzle of a pour spout such that the pour spout nozzle can be inserted through the receipt opening in a blocking disposition of the dust cover in which the dust cover is disposed on the upper portion of the pour spout nozzle, and the receipt opening of the skirt portion having a cross-sectional configuration configured with respect to the cross-sectional configuration of the upper portion of the pour spout nozzle such that the skirt portion exerts a radial inward compressive force on the pour spout nozzle in the blocking disposition of the dust cover.

A second embodiment of the invention provides a kit for capping a plurality of pour spouts of the type that are each positionable relative to the mouth of a neck of a bottle or other container to guide the dispensing of a substance from the bottle or other container bottles, each of the bottles having a pouring spout positioned within a mouth of the bottle, the kit comprising a plurality of dust covers, each of the dust covers including a skirt portion and a base portion, the skirt portion delimiting a receipt opening and a base portion, the skirt portion and the base portion together delimiting an interior space having a cover axis, the receipt opening delimited by the skirt portion forming one axial end of the interior space and the base portion forming an opposite axial end of the interior space, the receipt opening being compatibly configured with respect to a nozzle of a pour spout such that the pour spout nozzle can be inserted through the receipt opening in a blocking disposition of the dust cover in which the dust cover is disposed on the upper portion of the pour spout nozzle, and the receipt opening of the skirt portion having a cross-sectional configuration configured with respect to the cross-sectional configuration of the upper portion of the pour spout nozzle such that the skirt portion exerts a radial inward compressive force on the pour spout nozzle in the blocking disposition of the dust cover and a storage container configured to hold the plurality of dust covers.

A third embodiment of the invention provides a method of selectively blocking a nozzle of a pour spout of the type that is positionable relative to the mouth of a neck of a bottle or other container to guide the dispensing of a substance from the bottle or other container, the method comprising placing a dust cover on the pour spout nozzle in a blocking disposition in which the dust cover exerts a radial inward compressive force on the pour spout nozzle, the dust cover including a skirt portion and a base portion, the skirt portion delimiting a receipt opening and a base portion, the skirt portion and the base portion together delimiting an interior space having a cover axis, the receipt opening delimited by the skirt portion forming one axial end of the interior space and the base portion forming an opposite axial end of the interior space, the receipt opening being compatibly configured with respect to a nozzle of a pour spout such that the pour spout nozzle can be inserted through the receipt opening when the dust cover is disposed on its blocking disposition on the upper portion of the pour spout nozzle, and the receipt opening of the skirt portion having a cross-sectional configuration configured with respect to the cross-sectional configuration of the upper portion of the pour spout nozzle such that the skirt portion exerts a radial inward compressive force on the pour spout nozzle in the blocking disposition of the dust cover, leaving the dust cover on the bottle until a substance retained in the bottle or the other container is to be dispensed, and uncovering the pour spout nozzle via removal of the dust cover from its blocking position on the pour spout nozzle.

### BRIEF DESCRIPTION OF THE DRAWINGS

For a more complete understanding of the embodiments of the present invention, reference is now made to the following descriptions taken in connection with the accompanying drawings in which:

FIG. 1 is a front elevational view of a pour spout 10 of the type that can be secured onto an opening of a bottle or other container to provide controlled dispensing of the bottle contents;

FIG. 2 is a side elevational view of the pour spout shown in FIG. 1;

FIG. 3 is an enlarged perspective view of the dust cover of FIGS. 1 and 2; and

FIG. 4 is a perspective view of a storage tin.

### DETAILED DESCRIPTION OF AN EMBODIMENT

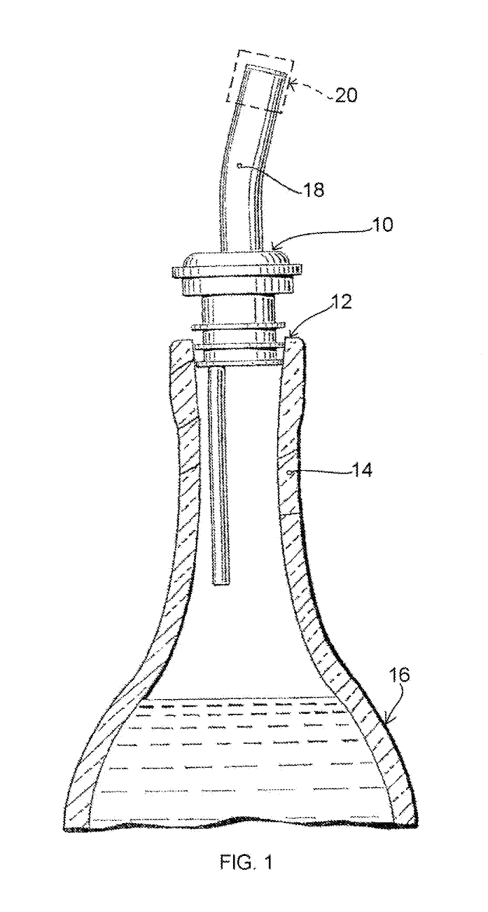

With reference now to FIGS. 1 - 3, one embodiment of the dust cover of the present invention will now be described. The dust cover provides a convenient, easily operable configuration that is particularly advantageous for preventing fruit flies and other nuisance insects from entering a bottle and contaminating its contents as well as preventing dust particles and other debris from entering a bottle. Moreover, the dust cover is optimally configured to be formed of environmentally friendly materials such as biodegradable materials or easily recyclable materials.

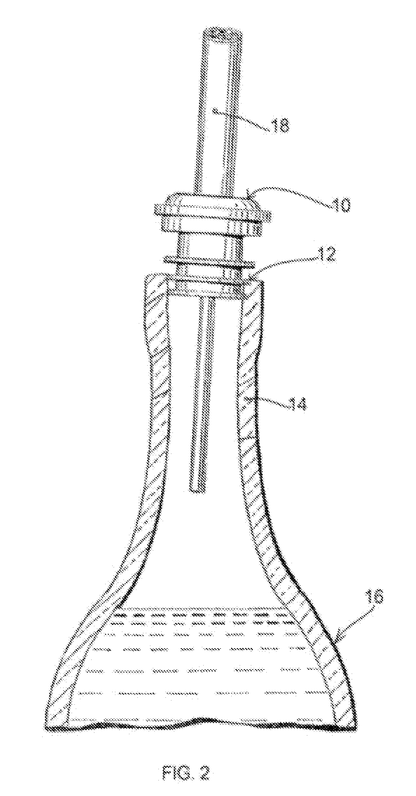

FIG. 1 is a front elevational view of a pour spout 10 of the type that can be secured onto an opening of a bottle or other container to provide controlled dispensing of the bottle contents and a container in the form of a glass bottle of the type on which the pour spout 10 can be deployed. FIG. 2 is a side elevational view of the pour spout shown in FIG. 1. The pour spout is removably insertable into, and removable from, the mouth 12 of the neck 14 of a bottle 16 or other container such that the pour spout 10, when fully inserted to reach its final securement position, is operable guide the dispensing of a substance from the bottle 16. For example, the contents of the bottle 16 may be a non-alcoholic beverage or an alcoholic beverage or another liquid or, alternatively, the contents may be a dry material such as spice particles or a condiment such as sugar or salt. With reference to FIGS. 1 and 2, these drawings show the pour spout 10 in a position in which the pour spout is partially inserted in the bottle 16 and is representative of a position that the pour spout 10 passes though as it is inserted in the bottle 16 or is removed from the bottle 16.

The pour spout 10 shown in FIG. 1 is exemplary of the numerous configurations of pour spouts that are available commercially or that have been proposed as useful for controlling the dispensing of the contents of a bottle. To be sure, bottles and other containers frequently are sold or provided in configurations in which the bottle or container has a removable closure such as, for example, a cork or a threaded cap. While it is possible to remove such a removable closure to unseal a bottle, for example, and then to replace such a removable closure on the bottle again in its closure position, many removable closures such as a bottle cork are not well suited to such a repetitive use routine. Moreover, it is frequently desired that the bottle remain in an easily deployable status for dispensing its contents after the originally provided removable closure has been removed. Thus, In retail outlets such as restaurants that serve alcoholic beverages along with food, as well as in establishments such as bars, taverns, nightclubs and other entertainment venues in which alcoholic beverages are served, there is a well-known practice in the handling of bottles and other containers that the original bottle cap or cork is first removed and then a pour spout is secured on these opened liquor bottles or other beverage bottles with the pour spout offering the convenience that it remains secured to the bottle between each dispensing use. The pour spout, for example, enables a bar attendant to pour an appropriate portion of liquor into a glass or into a measuring container such as a jigger (with the contents of the measuring container then being poured into a glass).

With continued reference to FIGS. 1 and 2, the pour spout 10 exemplarily illustrated is particularly configured for use by a bar attendant in pouring an appropriate portion of liquor into a glass or into a measuring container. The pour spout 10 is inserted into the neck 14 of the bottle 16 and has a nozzle 18 that projects outwardly from the mouth 12 of the bottle 16. Although the pour spout nozzle 18 has a smaller diameter than the mouth 12 of the bottle 16 on which the pour spout 10 is mounted, this nozzle 18 is nonetheless an enticing entry point for fruit flies or other nuisance insects that are attracted to the liquor or other contents retained in the bottle 16. The small size of fruit flies, and certain other insects, permits these insects to pass through the pour spout 10 and into the bottle 16. In this event, the entire bottle must be considered to be contaminated and prudent beverage serving protocol calls for the remaining liquor inside the bottle 16 to be discarded.

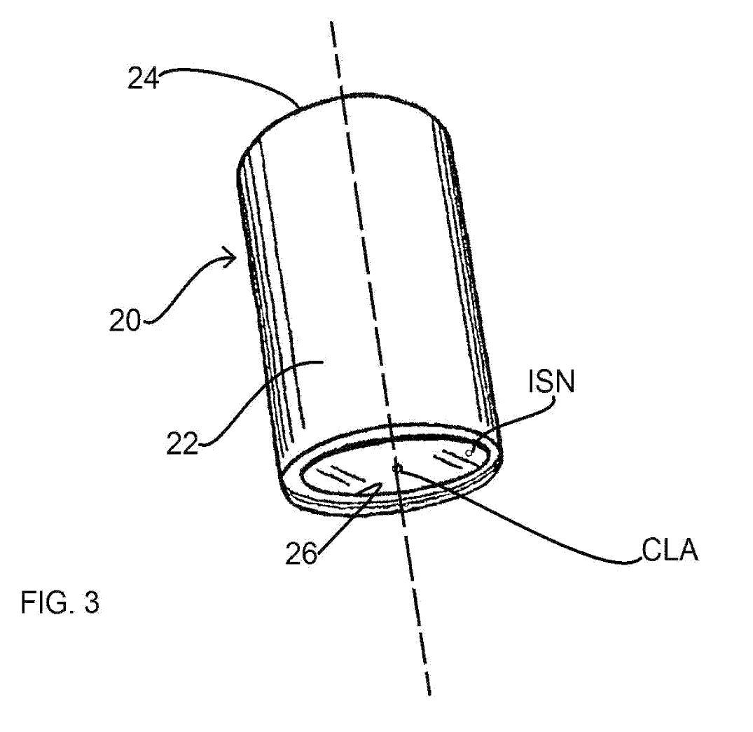

The present invention provides a convenient, reliable solution in the form of a dust cover 20 for selectively blocking the pour spout nozzle 18 to prevent the entry of insects, dust, or other substances into a container such as the bottle 16. The dust cover 20 is shown in broken lines in FIGS. 1 and 2 to illustrate the location of the dust cover 20 when it is in its blocking disposition on the pour spout nozzle 10. With reference now to FIG. 3, which is an enlarged perspective view of the dust cover 20, the dust cover 20 includes a skirt portion 22 and a base portion 24. The skirt portion 22 delimits a receipt opening 26. The skirt portion 22 and the base portion 24 together delimit an interior space ISN and the dust cover 20 has a cap axis CLA extending longitudinally through the interior space ISN. The receipt opening 26 delimited by the skirt portion 22 forms one axial end of the interior space ISN and the base portion 24 forms an opposite axial end of the interior space ISN. The receipt opening 26 is compatibly configured with respect to the pour spout nozzle 18 such that, when the dust cover 20 is guided toward the pour spout 10 to place the dust cover on the pour spout nozzle 18 so that the dust cover is in its blocking disposition, the pour spout nozzle 18 extends through the receipt opening 26 and into the interior space ISN with the base portion 24 of the dust cover ultimately contacting the pour spout nozzle 18 to prevent further axial insertion of the pour spout nozzle 18 into the dust cover. The receipt opening 26 of the skirt portion 22 has a cross-sectional configuration configured with respect to the cross-sectional configuration of the upper portion of the pour spout nozzle 18 such that the skirt portion 22 exerts a radial inward compressive force on the pour spout nozzle 18 in the blocking disposition of the dust cover 20. For example, if the cross-sectional configuration of the upper portion of the pour spout nozzle 18 is formed with a cylindrical conical geometry having a progressively smaller diameter in the direction of the open top of the pour spout nozzle 18, then the receipt opening 26 of the skirt portion 22 can be compatibly configured with a cross-sectional configuration with respect to this cross-sectional configuration of the pour spout nozzle 18 to ensure that the skirt portion 22 exerts a radial inward compressive force on the pour spout nozzle 18 in the blocking disposition of the dust cover 20. For example, the receipt opening 26 of the skirt portion 22 can be provided with an annular cross-sectional configuration whose diameter is slightly smaller than the respective diameter of the cylindrical conical upper portion of the pour spout nozzle 18 with this smaller diameter of the receipt opening 26 of the skirt portion 22 being selected such that the skirt portion 22 can be slid over the upper portion of the pour spout nozzle 18 until the annular periphery of the receipt opening 26 of the skirt portion 22 firmly engages the pour spout nozzle 18. This firm engagement of the receipt opening 26 of the skirt portion 22 with the pour spout nozzle 18 will ensure that the dust cover cannot easily be dislodged from the pour spout nozzle 18 in the event, for example, of inadvertent movement of the bottle 16, while at the same time permitting a person to readily remove the dust cover 20 from the pour spout 10 when it is desired to dispense some of the contents of the bottle 16.

The dust cover 20 can be releasably secured on the pour spout nozzle 18 by a “snug” fit as has been described hereinabove but it is also contemplated that the dust cover 20 can be appropriately secured by any other suitable approach and, in addition, it is also contemplated that the respective selected principal mode of securing the dust cover 20 to the pour spout nozzle 18 can be supplemented by a secondary mode of securement. One principal mode of securement is thus the above-disclosed approach in which the dust cover 20 is sized and dimensioned to engage the exterior surface of the pour spout nozzle 18 in a slight compressive “snug” fit. Such a slight compressive “snug” fit can be achieved by suitable dimensioning of the dust cover 20 relative to the full range of nozzles for pour spouts or, alternatively, relative to a selected range of pour spout nozzles. Additionally or alternatively, the desired slight compressive “snug” fit can be achieved by selection of the material forming the dust cover 20. As an example of a principal mode of securement that can be supplemented by a secondary mode of securement, the dust cover 20 can be dimensionally configured to achieve a slight compressive “snug” fit on the pour spout nozzle 18 as a principal mode of securement, as has been disclosed herein, and then the material of which the dust cover 20 is formed can be selected to enhance or reinforce the slight compressive “snug” fit. Numerous commercial configurations of pour spouts have been available whose nozzles are formed of a thin metal alloy or aluminum and it can be understood that the selection of a rubber or a flexible polymeric material for the dust cover 20 may promote a reliable releasable securement of the dust cover 20 on a pour spout nozzle formed of a metal alloy or aluminum, in view of the long-wearing tackiness of certain rubbers and polymers that leave only a minimal, if any, residue that could affect a beverage taste.

Further benefits may also be achieved if the material of the dust cover 20 is selected to substantially provide the desirable qualities of a dust cover formed of rubber or a flexible polymeric material while also providing environmental or sustainability benefits. For example, the dust cover can be formed of a biodegradable polymer or may be formed of a fibrous sheet that is itself biodegradable and coated or covered with a biodegradable polymer blend. Biodegradable polymers that may be used either to form the entirety of the dust cover or to treat a fibrous sheet that is itself formed into the shape of the dust cover include, but are not limited to, synthetic polyesters, naturally derived polyesters, polyester amides, polycarbonates, and polyester urethanes, but may also include a variety of natural polymers and their derivatives, such as polymers and derivatives of starch, cellulose, other polysaccharides, and proteins. Plasticizers may be added to impart desired softening and elongation properties. The terms “polymer blend” and “biodegradable polymer composition” includes two or more unfilled polymers and/or one or more polymers into which one or more types of solid fillers have been added that can behave as “soft” polymers. The polymer may be a thermoplastically processable starch polymer (TPS). In addition to thermoplastic starch or starch particles, other natural polymers that may be used within the polymer blends comprise or are derivatives of cellulose, other polysaccharides, polysaccharide gums and proteins. Examples of starches and starch derivatives include, but are not limited to, modified starches, cationic and anionic starches, and starch esters such as starch acetate, starch hydroxyethyl ether, alkyl starches, dextrins, amine starches, phosphates starches, and dialdehyde starches. Examples of derivatives of cellulose include, but are not limited to, cellulosic esters (e.g., cellulose formate, cellulose acetate, cellulose diacetate, cellulose propionate, cellulose butyrate, cellulose valerate, mixed esters, and mixtures thereof) and cellulosic ethers (e.g., methylhydroxyethylcellulose, hydroxymethylethylcellulose, carboxymethylcellulose, methylcellulose, ethylcellulose, hydroxyethylcellulose, hydroxyethylpropylcellulose, and mixtures thereof). Other polysaccharide-based polymers that can be incorporated into the polymer blends of the invention include alginic acid, alginates, phycocolloids, agar, gum arabic, guar gum, acacia gum, carrageenan gum, furcellaran gum, ghatti gum, psyllium gum, quince gum, tamarind gum, locust bean gum, gum karaya, xanthan gum, and gum tragacanth, and mixtures or derivatives thereof. Suitable protein-based polymers include, for example, a prolamine derived from corn, collagen and derivatives thereof such as gelatin and glue, casein, sunflower protein, egg protein, soybean protein, vegetable gelatins, gluten and mixtures or derivatives thereof.

Fibrous sheets made of paper or paperboard and made from natural cellulose-based fibers are biodegradable. Nonetheless, fibrous sheets may be porous and thus fail to prevent infiltration by water, oil or other liquids. Thus, the fibrous sheets used to form a dust cover may be treated with a liquid-resistant material, such as paraffin wax or plastic, although the loss in any biodegradable characteristic must be then taken into account. Such treated fibrous sheets may be, nonetheless, at least partially biodegradable. On the other hand, fibrous sheets that are coated or impregnated with biodegradable polymers or polymer blends so as to provide resistance to liquids can also be used to form the dust covers and such fibrous sheets that may be treated with biodegradable polymers include, but are not limited to, tissue papers, paper sheets, felts, paperboard, wovens and nonwovens.

Alternatively, a dust cover can be formed of a plastic such as polylactic acid polymers (PLA) or similar plastics which, like PLA, are visibly indistinguishable from normal plastics. Whether a dust cover is formed of fibrous materials or non-fibrous materials (e.g., polylactic acid polymer), an underlying portion of a dust cover can be formed of one type of material and a coating can be formed of a different material. Alternatively, the dust cover can be molded as a single piece composed of any selected fibrous material or non-fibrous material, whether fully or partially biodegradable or not biodegradable.

A coating operable as a permeation barrier on a dust cover can be formed of a material that is biodegradable and is composed, for example, of milk protein that is formed by mixing water, milk powder and vinegar to create a crud, separating the vinegar from crud, and then adding water and baking soda to the crud to form a milk protein glue. It is also contemplated that the coating may comprise a sugar cane protein. In addition, the coating can be composed of alternative Food and Drug Administration (FDA) approved food-grade adhesives, glazes and other biodegradable materials such as beta-hydroxybutryic acid polymer or other suitable coating materials. The coating can be applied via spraying, rolling, or other techniques that are known in the art, including for example lamination. In addition, the coating can be applied before, during, or after formation of an underlying portion of the dust cover.

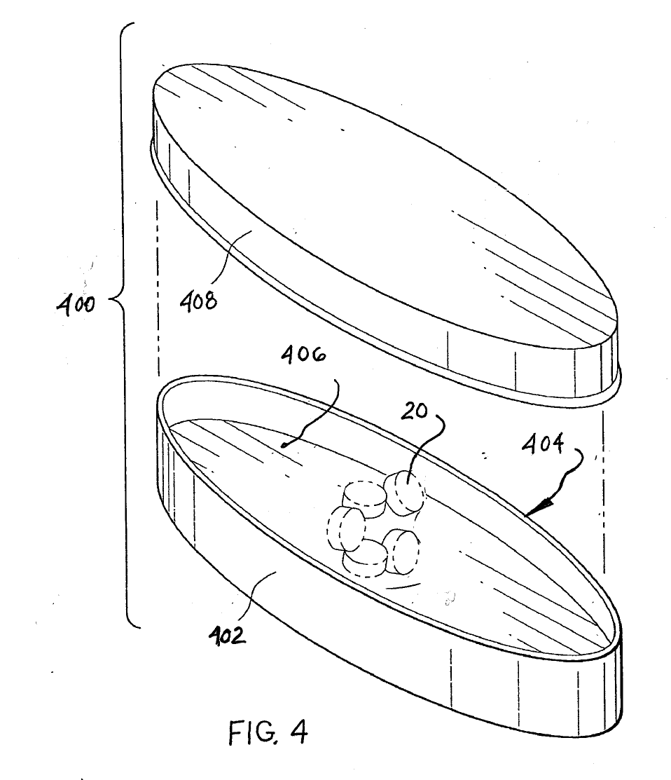

To facilitate the storage of dust covers in readiness for a first use of a respective dust cover or a re-use of a dust cover with respect to their pour spout covering function, or to facilitate the storage of expended dust cover for a later disposal in a facility for biodegradable materials or collection of non-biodegradable materials, the present invention provides a customized storage collector in the form of a rigid walled tin with a closeable lid. With reference now to FIG. 4, which is a perspective view of a storage tin 400, the storage tin 400 includes a sidewall portion 402, the sidewall portion delimiting an open top end 404, a closed bottom end 406 connected to the sidewall portion 402, and a removable lid 408. The geometry and surface of the removable lid 408 is preferably configured to accommodate advertising indicia, such as logos, brand or product names, and the like, and provides an establishment with a professional and neat appearance, and provides a reassurance to customers as to the good environmental and hygiene practices of the establishment.

In operation, the dust covers can be removed from the storage tin 400 and placed on pour spouts that are installed on bottles. The dust covers may be kept on the pour spouts while the establishment is open, simply being removed to allow pouring, and can remain on the pour spouts during the closing hours of the establishment. Alternatively, the dust covers can be removed from group wise from the pour spouts during selected times when the bottles having the pour spouts are in frequent use and the dust covers can then be placed again into their covering locations on the pour spouts.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A dust cover, the dust cover being disposable on a nozzle of a pour spout of the type that is positionable relative to the mouth of a neck of a bottle or other container to guide the dispensing of a substance from the bottle or other container, the dust cover comprising:
a skirt portion, the skirt portion delimiting a receipt opening; and
a base portion, the skirt portion and the base portion together delimiting an interior space having a cover axis, the receipt opening delimited by the skirt portion forming one axial end of the interior space and the base portion forming an opposite axial end of the interior space, the receipt opening being compatibly configured with respect to a nozzle of a pour spout such that the pour spout nozzle can be inserted through the receipt opening in a blocking disposition of the dust cover in which the dust cover is disposed on the upper portion of the pour spout nozzle, and the receipt opening of the skirt portion having a cross-sectional configuration configured with respect to the cross-sectional configuration of the upper portion of the pour spout nozzle such that the skirt portion exerts a radial inward compressive force on the pour spout nozzle in the blocking disposition of the dust cover.

2. The dust cover according to claim 1, wherein the dust cover is formed of materials each of which is at least a compostable material or a recyclable material.

3. The dust cover according to claim 1, wherein the dust cover is formed from at least one of a biodegradable plastic resin and a corn-based polylactic acid polymer (PLA).

4. The dust cover according to claim 5, wherein the dust cover is coated with a coating to resist penetration of moisture and air.

5. The dust cover according to claim 1, wherein the dust cover is formed of rubber.

6. The dust cover according to claim1, wherein the dust cover has a smooth coating.

7. The dust cover according to claim 1, wherein the dust cover is made from a material having a memory capability to the extent that the dust cover can be deformed from an original shape by a deformation force and will automatically return to the original shape upon cessation of the deformation force.

8. A kit for capping a plurality of pour spouts of the type that are each positionable relative to the mouth of a neck of a bottle or other container to guide the dispensing of a substance from the bottle or other container bottles, each of the bottles having a pouring spout positioned within a mouth of the bottle, the kit comprising:
a plurality of dust covers, each of the dust covers including a skirt portion and a base portion, the skirt portion delimiting a receipt opening and a base portion, the skirt portion and the base portion together delimiting an interior space having a cover axis, the receipt opening delimited by the skirt portion forming one axial end of the interior space and the base portion forming an opposite axial end of the interior space, the receipt opening being compatibly configured with respect to a nozzle of a pour spout such that the pour spout nozzle can be inserted through the receipt opening in a blocking disposition of the dust cover in which the dust cover is disposed on the upper portion of the pour spout nozzle, and the receipt opening of the skirt portion having a cross-sectional configuration configured with respect to the cross-sectional configuration of the upper portion of the pour spout nozzle such that the skirt portion exerts a radial inward compressive force on the pour spout nozzle in the blocking disposition of the dust cover; and
a storage container configured to hold the plurality of dust covers.

9. The kit according to claim 8, wherein the storage container is dishwasher-safe.

10. The kit according to claim 8, wherein the storage container includes a peripheral side wall that extend above a top of the plurality of dust covers when the plurality of dust covers are placed in the storage container.

11. The kit according to claim 8, wherein the storage container includes at least a pair of compartments each for retaining a group of dust covers separate from another group of dust covers that may be retained in other compartments.

12. The kit according to claim 8, wherein the dust covers are formed of materials each of which is at least a compostable material or a recyclable material.

13. The kit according to claim 8, wherein the dust covers are formed from at least one of a biodegradable plastic resin and a corn-based polylactic acid polymer (PLA).

14. The kit according to claim 8, wherein the dust covers are coated with a coating to resist penetration of moisture and air.

15. The kit according to claim 8, wherein the storage container includes a sidewall portion, the sidewall portion delimiting an open top end, a closed bottom end connected to the sidewall portion, and a removable lid.

16. A method of selectively blocking a nozzle of a pour spout of the type that is positionable relative to the mouth of a neck of a bottle or other container to guide the dispensing of a substance from the bottle or other container, the method comprising:
placing a dust cover on the pour spout nozzle in a blocking disposition in which the dust cover exerts a radial inward compressive force on the pour spout nozzle, the dust cover including a skirt portion and a base portion, the skirt portion delimiting a receipt opening and a base portion, the skirt portion and the base portion together delimiting an interior space having a cover axis, the receipt opening delimited by the skirt portion forming one axial end of the interior space and the base portion forming an opposite axial end of the interior space, the receipt opening being compatibly configured with respect to a nozzle of a pour spout such that the pour spout nozzle can be inserted through the receipt opening when the dust cover is disposed on its blocking disposition on the upper portion of the pour spout nozzle, and the receipt opening of the skirt portion having a cross-sectional configuration configured with respect to the cross-sectional configuration of the upper portion of the pour spout nozzle such that the skirt portion exerts a radial inward compressive force on the pour spout nozzle in the blocking disposition of the dust cover;
leaving the dust cover on the bottle until a substance retained in the bottle or the other container is to be dispensed; and
uncovering the pour spout nozzle via removal of the dust cover from its blocking position on the pour spout nozzle.

17. The method according to claim 16, wherein the step of leaving the dust cover on the bottle includes leaving the dust cover on the bottle overnight.
